(19) United States
(12) Patent Application Publication
(10) Pub. No.: US 2024/0391638 A1
(43) Pub. Date: Nov. 28, 2024

(54) PACKING BOX AND PACKING ASSEMBLY HAVING THE SAME

(71) Applicant: Huizhou Shifang Packaging New Material Co., Ltd, Huizhou City (CN)

(72) Inventor: Yun Dan Huang, Huizhou City (CN)

(73) Assignee: Huizhou Shifang Packaging New Material Co., Ltd, Huizhou City (CN)

(21) Appl. No.: 18/207,919

(22) Filed: Jun. 9, 2023

(30) Foreign Application Priority Data
May 23, 2023 (CN) 2023212733262

(51) Int. Cl. B65D 5/02; B65D 5/36; B65D 5/50; B65D 81/02

(52) U.S. Cl. CPC B65D 5/0281; B65D 5/3628; B65D 5/5028; B65D 65/44

(57) ABSTRACT

Disclosed are a packing box and a packing assembly having the same. The packing box includes a first plate module and a second plate module, the first auxiliary plate and the second auxiliary plate. In the folded state, it is a multi-layer stacked structure, which can reduce manufacturing costs and transportation costs. It is a packing box and a packing assembly having the same that can be quickly and conveniently packed by a user.

This application claims priority for China patent application no. 2023212733262 filed on May 23, 2023, the content of which is incorporated by reference in its entirely.

### BACKGROUND OF THE INVENTION

### Field of the Invention

The invention provides a packing box and a packing assembly, in particular, to a packing box with a multi-layer stacked structure in a folded state and a packing assembly having the same.

### Description of the Prior Art

Conventionally, boxes or containers used in industrial packing are often transported due to their bulky size and cannot be shrunk. Especially in the period when raw materials are soaring, not only the manufacturing cost of the main body has increased, but also the transportation cost of transportation has also increased sharply. In addition, for the user, packing boxes or packing containers, as the name suggests, are used to protect items so that they can be transported to their destinations properly. However, most of the conventional packing boxes or packing containers only have a structure of outer containers without a protective structure, or protect parts of the items but cannot properly protect the whole.

When large furniture (such as wardrobes, cabinets, bed sets) and large electrical appliances (such as air conditioners, refrigerators, televisions) are purchased in certain countries, the manufacturer may not be able to pick up the package at home due to the vast geographical area if the user encounters a damage event during use, and then the user is obliged to send it out for repair. However, for the user, packing materials for large furniture or electrical appliances are very difficult to obtain. Therefore, in most cases, the manufacturer must send and provide these packing materials to the user for packing, so that the user can quickly pack and send it back to the manufacturer. As mentioned above, the overall process and steps of shipping the packing materials from the manufacturer to the user, and then packing the items from the user and sending them back to the manufacturer must consume a lot of economic costs, and quite tests the packing ability of the user.

Thus, for the problems of the above-mentioned prior art, the invention further provides a packing box and a packing assembly having the same so as to solve the problems arising from the conventional art.

### SUMMARY OF THE INVENTION

In view of the above problems, an objective of the invention is to provide a packing box and a packing assembly having the same that can reduce manufacturing costs and transportation costs, and can be quickly and conveniently packed by the user himself.

In order to achieve the above objective, the invention provides a packing box, which includes a first plate module and a second plate module, the first auxiliary plate and the second auxiliary plate. The first plate module and the second plate module are of the same structure, and both the first plate module and the second plate module include a first panel and a second panel respectively. The first panel includes a first main plate portion, a first upper closing portion and a first lower closing portion, wherein the first main plate portion is connected with the first upper closing portion, and a position where the first main plate portion is connected with the first upper closing portion is a first folded edge; the first main plate portion is connected with the first lower closing portion, and a position where the first main plate portion is connected with the first lower closing portion is a second folded edge. The second panel includes a second main plate portion, a second upper closing portion and a second lower closing portion, wherein the second main plate portion is connected with the second upper closing portion, and a position where the second main plate portion is connected with the second upper closing portion being a third folded edge; the second main plate portion is connected with the second lower closing portion, and a position where the second main plate portion is connected with the second lower closing portion is a fourth folded edge; the second main plate portion, the second upper closing portion and the second lower closing portion are respectively provided with a bending area, a plurality of the bending areas are connected with each other, and at least one deformed bending line is included between the plurality of the bending areas. The first main plate portion of the first plate module is connected with the second main plate portion of the second plate module, and the second main plate portion of the first plate module is connected with the first main plate portion of the second plate module.

The first auxiliary plate is disposed at the first plate module, wherein one side of the first auxiliary plate is disposed on the second main plate portion of the first plate module, and the other side of the first auxiliary plate is movably in contact with the first main plate portion or the second main plate portion; in a folded state, the first auxiliary plate is attached to the first main plate portion of the first plate module, and in an unfolded state, the first auxiliary plate is attached to the second main plate portion of the first plate module. The second auxiliary plate is disposed at the second plate module, wherein one side of the second auxiliary plate is disposed on the second main plate portion of the second plate module, and the other side of the second auxiliary plate is movably in contact with the first main plate portion or the second main plate portion; in the folded state, the second auxiliary plate is attached to the first main plate portion of the second plate module, and in the unfolded state, the second auxiliary plate is attached to the second main plate portion of the second plate module.

The first main plate portion, the first upper closing portion, the first upper closing portion, the second main plate portion, the second upper closing portion and the second lower closing portion are provided with an inner receiving surface and an outer receiving surface that are opposite to each other respectively; the first auxiliary plate and the second auxiliary plate are provided with an inner contact surface and an outer reinforced surface that are opposite to each other respectively.

In the folded state, the packing box is a multi-layer stacked structure, and a stack type of the multi-layer stacked structure is:
in the first plate module, the first upper closing portion partially overlaps the first lower closing portion, and the outer surface of the first upper closing portion and the outer surface of the first lower closing part are in contact with the outer surface of the first main plate portion, the inner receiving surface of the first main plate portion being in contact with the inner contact surface of the first auxiliary plate;
in the second plate module, the first upper closing portion partially overlaps the first lower closing portion, and the outer surface of the first upper closing portion and the outer surface of the first lower closing part are in contact with the outer surface of the first main plate portion, the inner receiving surface of the first main plate portion being in contact with the inner contact surface of the second auxiliary plate;
in the first plate module, the second upper closing portion partially overlaps the second lower closing portion and is bent along the plurality of the deformed bending lines, and the inner receiving surface of the second upper closing portion, the inner receiving surface of the second lower closing portion are in contact with the inner receiving surface of the second main plate portion, the outer surface of the second main plate portion being centered on the deformed bending line so that the outer surfaces are folded and in contact with each other; and
in the first plate module and the second plate module, the outer surface of the second upper closing portion and the outer surface of the second lower closing portion are bent with the deformed bending line as a center, so that the outer surface of the second upper closing portion and the outer surface of the second lower closing portion are in contact with the outer reinforced surface of the first auxiliary plate and the outer reinforced surface of the second auxiliary plate respectively, and the deformed bending lines of the plurality of bending areas are close to a middle of the first main plate portion.

In order to achieve the above objective, the invention further provides a packing assembly having the packing box, and the packing assembly includes a housing, the packing box and an auxiliary box. The packing box is disposed in the housing in the folded state. The auxiliary box is disposed in the housing and adjacent to the packing box, and the auxiliary box includes the at least one foam packing bag in a folded shape.

The auxiliary box is connected with the housing to prevent the auxiliary box from falling.

The foam bag includes an outer bag body and an inner bag body, and the inner bag body is located in the outer bag body, the inner bag body being smaller than the outer bag body, the inner bag body being provided with a first reaction area and a second reaction area that are adjacent to each other; a first reactant is provided in the first reaction area, and a second reactant is provided in the second reaction area; in the unfolded state, the first reactant reacts with the second reactant to form a foam after being mixed with each other.

As mentioned above, the packing box and the packing assembly having the same according to the invention may not only reduce the overall volume in the folded state, but also reduce manufacturing costs and transportation costs while providing a user with a more convenient experience.

### BRIEF DESCRIPTION OF THE DRAWINGS

FIG. 1 is a three-dimensional diagram 1 of a first embodiment of a packing box according to the invention;

FIG. 2 is a diagram showing the disassembly of the first embodiment of the packing box according to the invention;

FIG. 3 is a diagram showing an unfolded state of the first embodiment of the packing box according to the invention;

FIG. 4 is a three-dimensional diagram 2 of a first embodiment of a packing box according to the invention;

FIG. 5 is a three-dimensional diagram 3 of a first embodiment of a packing box according to the invention;

FIG. 6 is a cross-sectional diagram of part C1 in FIG. 5;

FIG. 7 is a cross-sectional diagram of part C2 in FIG. 5;

FIG. 8 is a diagram 1 showing a folded state of the first embodiment of the packing box according to the invention;

FIG. 9 is a diagram 2 showing a folded state of the first embodiment of the packing box according to the invention;

FIG. 10 is a diagram of a second embodiment of the packing box according to the invention;

FIG. 11 is a diagram of an embodiment of a foam packing bag according to the invention;

FIG. 12 is a diagram of an embodiment of a packing assembly according to the invention.

### DESCRIPTION OF THE PREFERRED EMBODIMENTS

Embodiments of the invention will be further explained with the help of the related drawings below. Wherever possible, in the drawings and the description, the same reference numbers refer to the same or similar components. In the drawings, shapes and thicknesses may be exaggerated for simplicity and convenience. It should be understood that the elements not particularly shown in the drawings or described in the specification have forms known to those skilled in the art. Those skilled in the art can make various changes and modifications based on the content of the invention.

It should be understood that although terms “first”, “second”, etc. may be used herein to describe various elements, each element should not be limited by the foregoing terms. The foregoing terms are mainly used to distinguish one element from another, rather than to indicate a sequential order.

In the description, the first plate module 1 has the same structure as the second plate module 1′, and the first auxiliary plate 30 has the same structure as the second auxiliary plate 40. For the sake of simplicity and clarity, elements with the same structure described below will be marked with the same reference numerals.

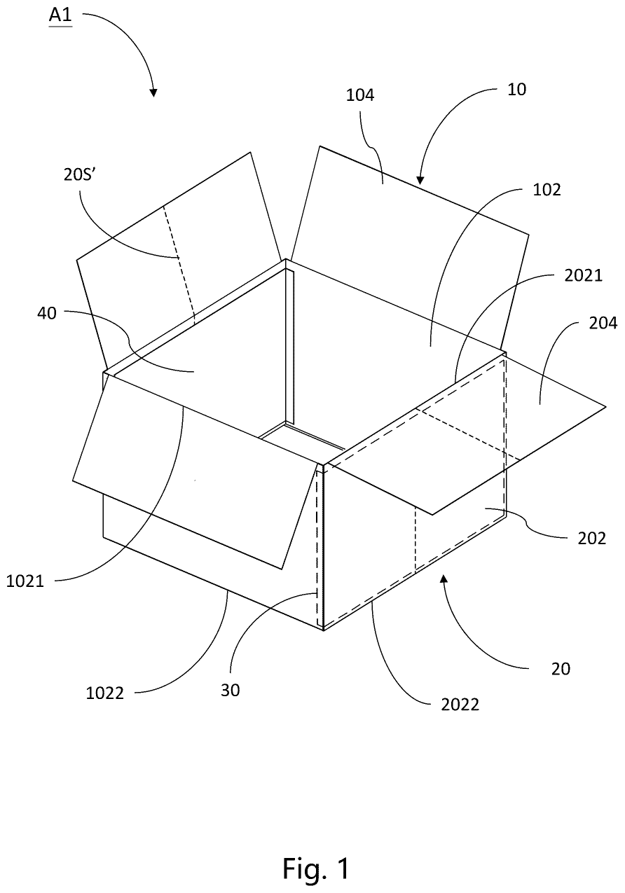

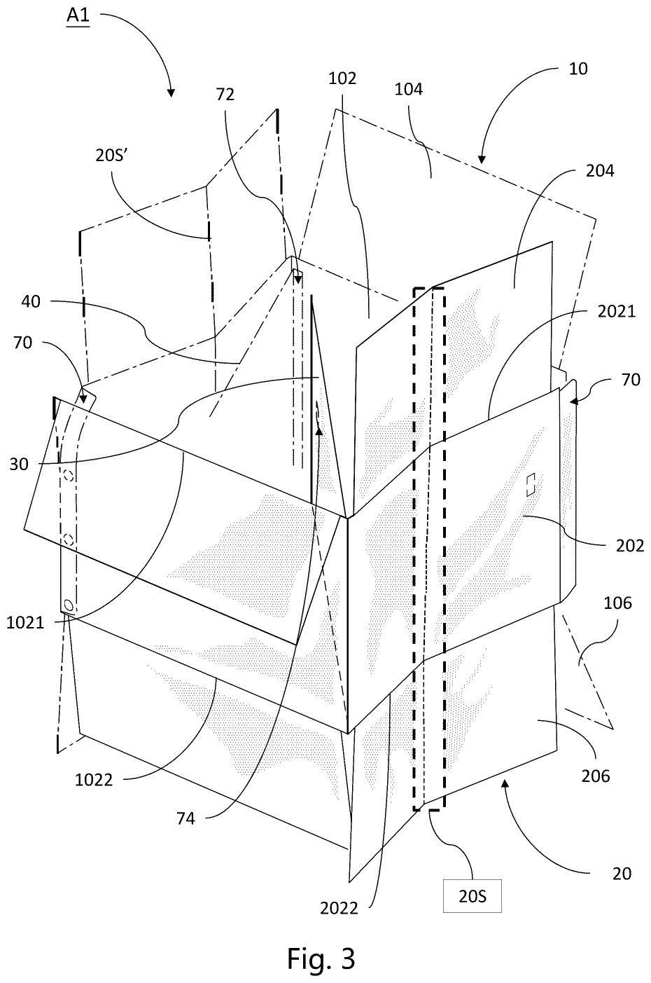

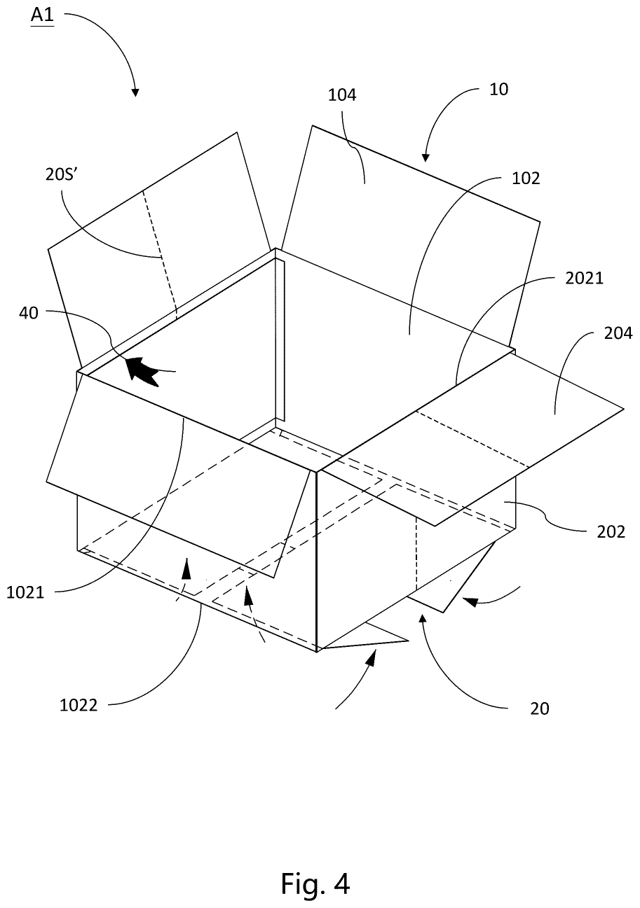

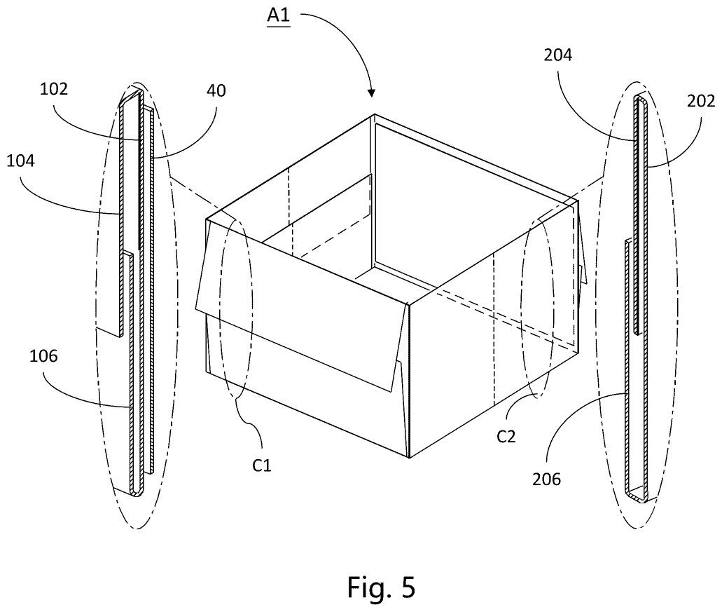

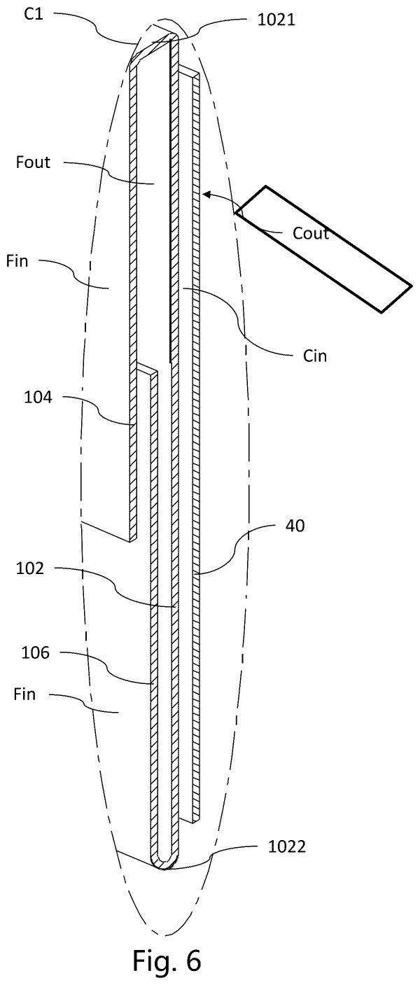

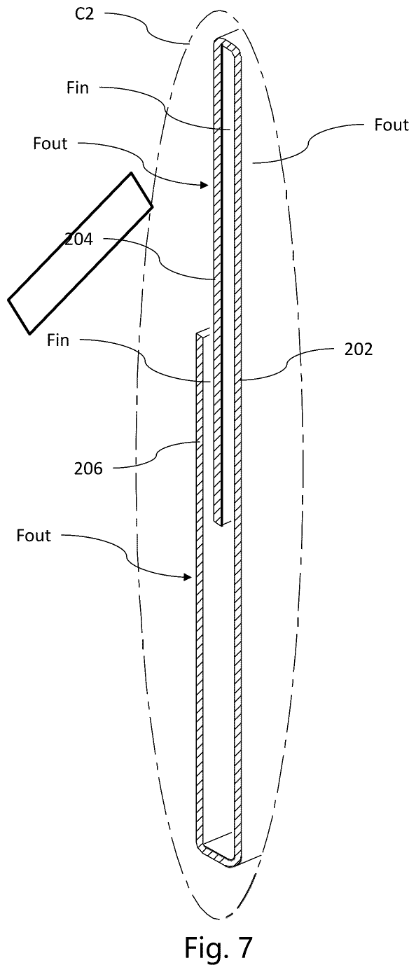

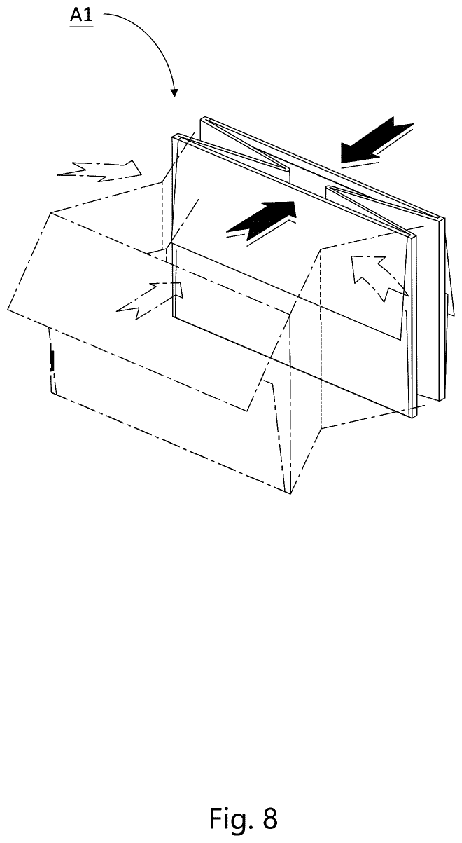

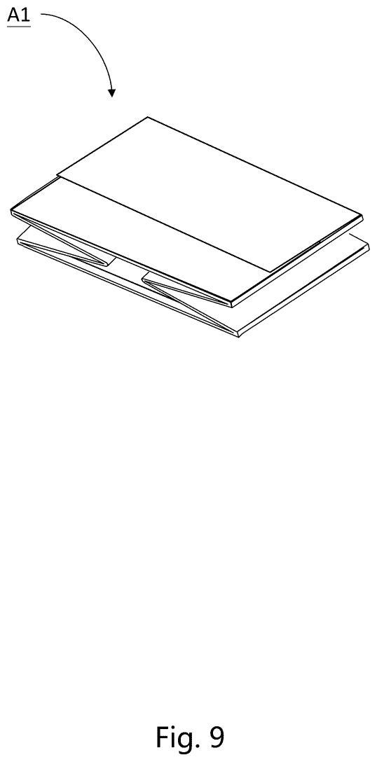

With reference to FIGS. 1 to 9, in a first embodiment, a packing box A1 includes a first plate module 1 and a second plate module 1′, a first auxiliary plate 30, and a second auxiliary plate 40. The first plate module 1 and the second plate module 1′ include a first panel 10 and a second panel 20 respectively. The first panel 10 includes a first main plate portion 102, a first upper closing portion 104, and a first lower closing portion 106, wherein the first main plate portion 102 is connected with the first upper closing portion 104, and a position where the first main plate portion 102 is connected with the first upper closing portion 104 is a first folded edge 1021; the first main plate portion 102 is connected with the first lower closing portion 106, and a position where the first main plate portion 102 is connected with the first lower closing portion 106 is a second folded edge 1022. The second panel 20 includes a second main plate portion 202, a second upper closing portion 204, and a second lower closing portion 206, wherein the second main plate portion 202 is connected with the second upper closing portion 204, and a position where the second main plate portion 202 is connected with the second upper closing portion 204 being a third folded edge 2021; the second main plate portion 202 is connected with the second lower closing portion 206, and a position where the second main plate portion 202 is connected with the second lower closing portion 206 is a fourth folded edge 2022; the second main plate portion 202, the second upper closing portion 204 and the second lower closing portion 206 are respectively provided with a bending area 20S, a plurality of the bending areas 20S are connected with each other, and at least one deformed bending line 20S′ is included between the plurality of the bending areas 20S. The first main plate portion 102 of the first plate module 1 is connected with the second main plate portion 202 of the second plate module 1′, and the second main plate portion 202 of the first plate module 1 is connected with the first main plate portion 102 of the second plate module 1′.

The first auxiliary plate 30 is disposed at the first plate module 1, wherein one side of the first auxiliary plate 30 is disposed on the second main plate portion 202 of the first plate module 1, and the other side of the first auxiliary plate 30 is movably in contact with the first main plate portion 102 or the second main plate portion 202; in a folded state, the first auxiliary plate 30 is attached to the first main plate portion 102 of the first plate module 1, and in an unfolded state, the first auxiliary plate 30 is attached to the second main plate portion 202 of the first plate module 1.

The second auxiliary plate 40 is disposed at the second plate module 1′, wherein one side of the second auxiliary plate 40 is disposed on the second main plate portion 202 of the second plate module 1′, and the other side of the second auxiliary plate 40 is movably in contact with the first main plate portion 102 or the second main plate portion 202; in a folded state, the second auxiliary plate 40 is attached to the first main plate portion 102 of the second plate module 1′, and in an unfolded state, the second auxiliary plate 40 is attached to the second main plate portion 202 of the second plate module 1′.

The first plate module 1 is connected with the second plate module 1′ by a first connecting portion 70, and the first connecting portion 70 is formed by one of ultrasonic heat pressing, nailing, glue coating and double-sided tape sticking. However, in other embodiments, there may not be the first connecting portion 70 between the first plate module 1 and the second plate module 1′, and the first plate module 1 and the second plate module 1′ may be integrally formed with each other.

The first auxiliary plate 30 is connected with the first plate module 1, and the second auxiliary plate 40 is connected with the second plate module 1′, by a second connecting portion 72, and the second connecting portion 72 is formed by one of ultrasonic heat pressing, nailing, glue coating and tether binding.

In the unfolded state, the other side of the first auxiliary plate 30 is connected with the other side of the second auxiliary plate 40 by a third connecting portion 74, and the third connecting portion 74 is formed by one of Velcro sticking, glue coating, double-sided tape sticking and tether binding.

From the folded state to the unfolded state, a moving angle of the first auxiliary plate 30 and a moving angle of the second auxiliary plate 40 are between 0° and 90°.

The first main plate portion 102, the first upper closing portion 104, the first upper closing portion 106, the second main plate portion 202, the second upper closing portion 204 and the second lower closing portion 206 are provided with an inner receiving surface Fin and an outer receiving surface Fout that are opposite to each other respectively; the first auxiliary plate 30 and the second auxiliary plate 40 are provided with an inner contact surface Cin and an outer reinforced surface Cout that are opposite to each other respectively.

In the folded state, the packing box is a multi-layer stacked structure.

A stack type of the multi-layer stacked structure is: in the first plate module 1, the first upper closing portion 104 partially overlaps the first lower closing portion 106, and the outer surface Fout of the first upper closing portion 104 and the outer surface Fout of the first lower closing portion 106 are in contact with the outer surface Fout of the first main plate portion 102, the inner receiving surface Fin of the first main plate portion 102 being in contact with the inner contact surface Cin of the first auxiliary plate 30;

in the second plate module 1′, the first upper closing portion 104 partially overlaps the first lower closing portion 106, and the outer surface Fout of the first upper closing portion 104 and the outer surface Fout of the first lower closing portion 106 are in contact with the outer surface Fout of the first main plate portion 102, the inner receiving surface Fin of the first main plate portion 102 being in contact with the inner contact surface Cin of the second auxiliary plate 40;

in the first plate module 1, the second upper closing portion 204 partially overlaps the second lower closing portion 206 and is bent along the plurality of the deformed bending lines 20S′, and the inner receiving surface Fin of the second upper closing portion 204, the inner receiving surface Fin of the second lower closing portion 206 are in contact with the inner receiving surface Fin of the second main plate portion 202, the outer surface Fout of the second main plate portion 202 being centered on the deformed bending line 20S′ so that the outer surfaces Fout are folded and in contact with each other; and
in the first plate module 1 and the second plate module 1′, the outer surface Fout of the second upper closing portion 204 and the outer surface Fout of the second lower closing portion 206 are bent with the deformed bending line 20S′ as a center, so that the outer surface Fout of the second upper closing portion 204 and the outer surface Fout of the second lower closing portion 206 are in contact with the outer reinforced surface Cout of the first auxiliary plate 30 and the outer reinforced surface Cout of the second auxiliary plate 40 respectively, and the deformed bending lines 20S′ of the plurality of bending areas 20S are close to a middle of the first main plate portion 102.

The packing box A1 that may be folded when shipped by the manufacturer is provided to the user, and the user unfolds it into the unfolded state. After the user uses it, it can also be folded and stored for repeated use in the future, and the packing box A1 may be folded from the unfolded state to the folded state. The first upper closing portion 104 and the first lower closing portion 106 may be turned out of the box along the first folded edge 1021 and the second folded edge 1022 respectively, and abut against the outer surface Fout of the first main plate portion 102. The second upper closing portion 204 and the second lower closing portion 206 may be turned into the box along the third folded edge 2021 and the fourth folded edge 2022 respectively, and abut against the inner receiving surface Fin of the second main plate portion 202.

Then, the first auxiliary plate 30 and second auxiliary plate 30 move towards the first main plate portion 102 of the first plate module 1 and the first main plate portion 102 of the second plate module 1′ respectively, so that the first auxiliary plate 30 and the second auxiliary plate 40 respectively abut against the inner receiving surface Fin of the first main plate portion 102 of the first plate module 1 and the inner receiving face Fin of the first main plate portion 102 of the second plate module 1′. Finally, the second main plate portion 202 on both sides of the first plate module 1 and the second plate module 1′ may be bent toward the inside of the box along the deformed bending line 20S′, so that the packing box A1 will be in the folded state.

Further, a material of the first plate module 1, the second plate module 1′, the first auxiliary plate 30 or the second auxiliary plate 40 is one of plastic, decomposable plastic, paper, corrugated fiberboard or artificial fiber, but not limited thereto.

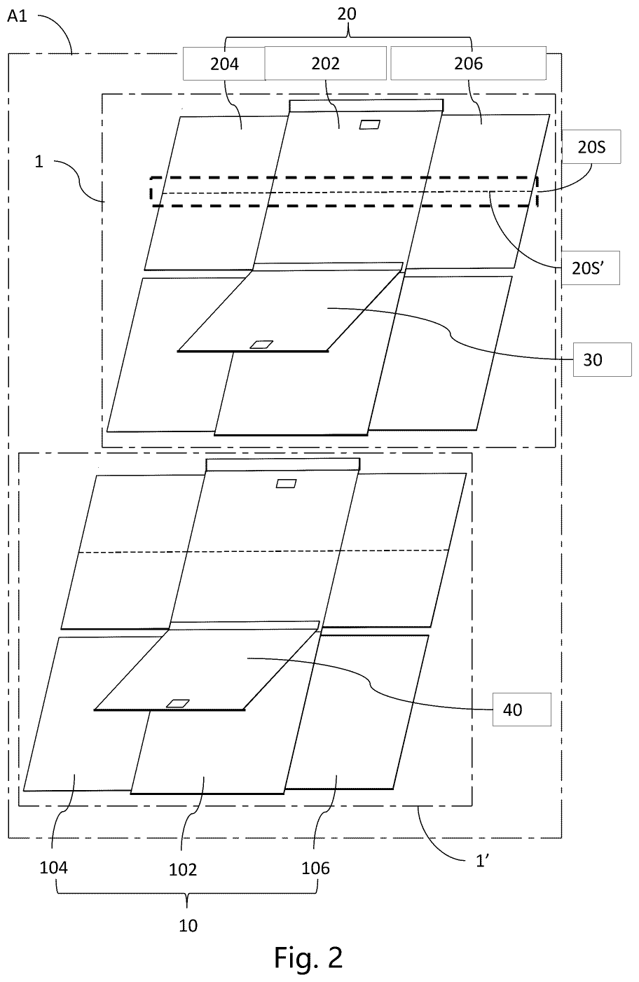

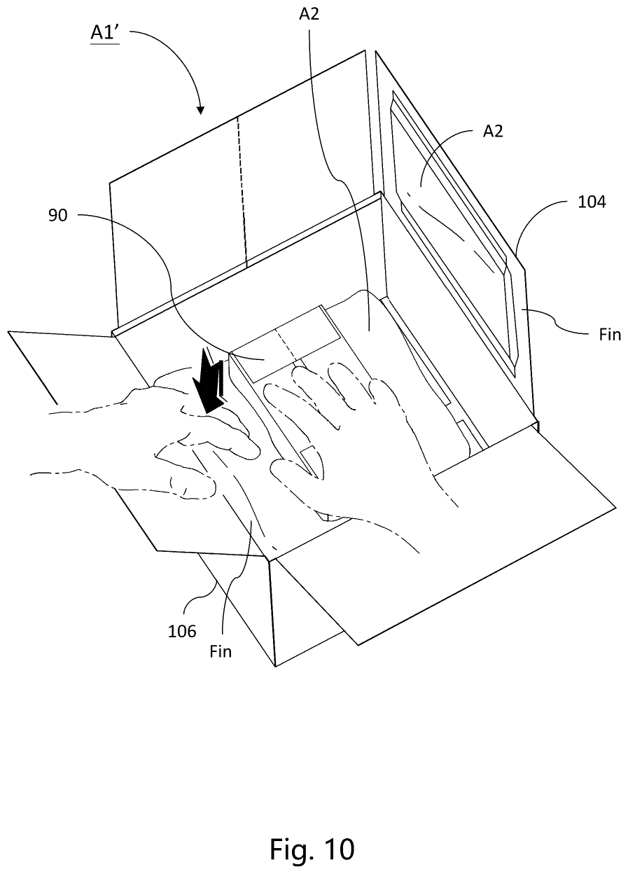

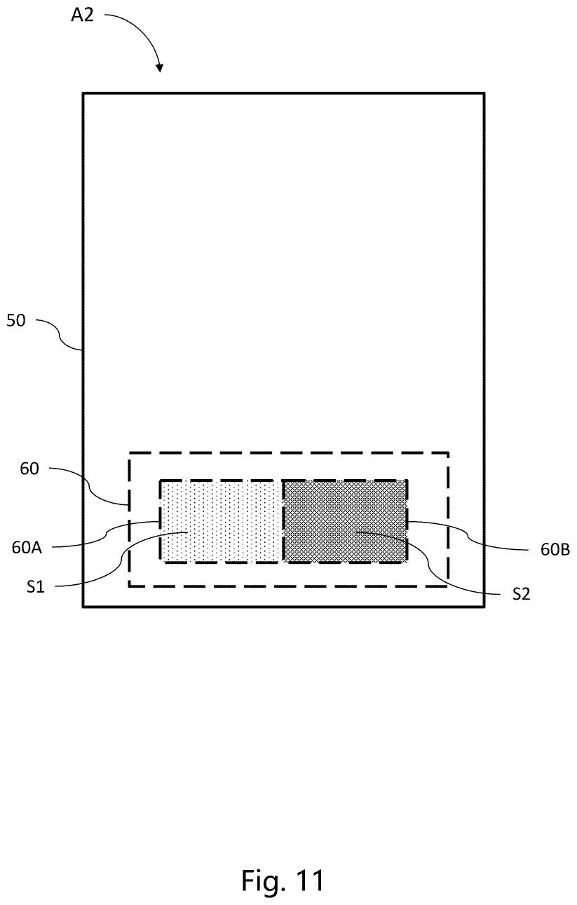

With reference to FIGS. 2, 10, and 11, a second embodiment differs from the first embodiment in that a packing box A1′ of the second embodiment is further provided with at least one foam packing bag A2. FIG. 10 is a diagram of the user's operation when placing an article 90, and FIG. 11 shows the state of the foam packing bag A2 unfolded but not yet foamed. The foam packing bag A2 may be located in the first lower closing portion 106 and the first upper closing portion 104 of the first plate module 1, or one of the first lower closing portion 106 and the first upper closing portion 104 of the second plate module 1′.

The at least one foam packing bag A2 includes an outer bag body 50 and an inner bag body 60, wherein the inner bag body 60 is located inside the outer bag body 50, and the inner bag body 60 is provided with a first reaction area 60A and a second reaction area 60B that are adjacent to each other; the first reaction area 60A is provided inside with a first reactant S1, and the second reaction area 60B is provided inside with a second reactant S2; in the unfolded state, the first reactant S1 reacts with the second reactant S2 to form a foam after being mixed with each other, which bursts the inner bag body 60 and fills the outer bag body 50 with the foam.

In the second embodiment, the number of foam packing bags A2 is two, which are respectively disposed on the inner receiving surface Fin of the first upper closing portion 104 and the inner receiving surface Fin of the first lower closing portion 106, but the actual number and positions are not limited thereto.

When the user has a demand for packing the article 90, the first reaction area 60A and the second reaction area 60B in the foam packing bag A2 located on the first lower closing portion 106 are compressed to make the first reactant S1 mix with the second reactant S2 and react with each other to form a foam and expand the bag, and then the article 90 is placed on; subsequently, similar to the above, the foam packing bag A2 located at the first upper closure part 104 may be continuously pressed to make the first reactant S1 and the second reactant S2 in the first reaction area 60A and the second reaction area 60B mix and react with each other to expand the bag; in this way, the packing is performed through the two foam packing bags A2 pasted on the upper and lower sides of the packing box A1′, which provides the user with a convenient packing experience without the need to purchase or use packing materials, which is quite convenient. The size of the article 90 in the figures is just an example, and in the actual environment, the situation includes packing large furniture (such as wardrobes, cabinets), large electrical appliances (such as air conditioners, refrigerators), etc., which is not limited thereto.

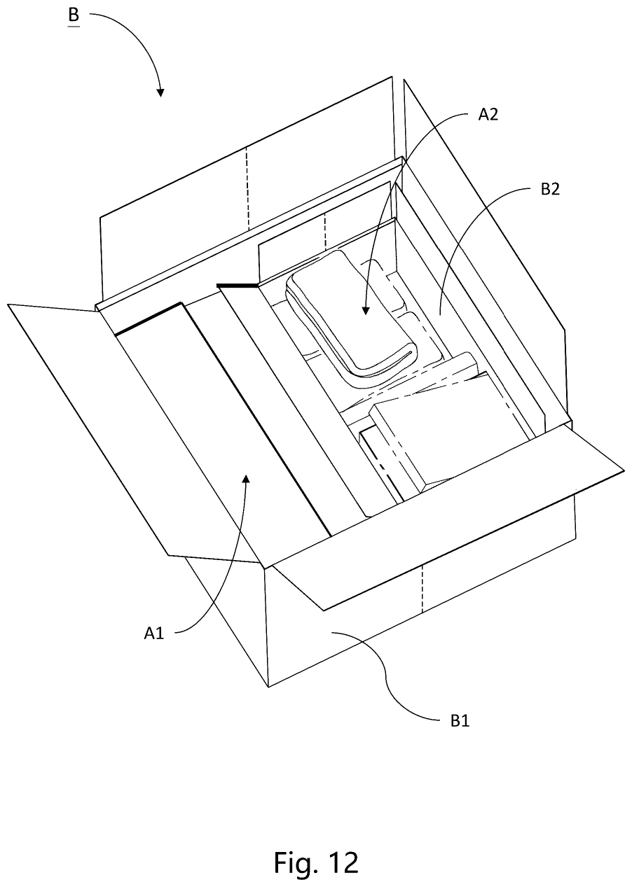

With reference to FIG. 12, a packing assembly B includes a housing B1, the packing box A1 and an auxiliary box B2, and the packing box A1 in the embodiment has the same structure as that of the first embodiment, so it will not be repeated here. The packing box A1 is disposed in the housing B1 in the folded state. The auxiliary box B2 is disposed in the housing B1 and adjacent to the packing box A1, and the auxiliary box B2 includes the at least one foam packing bag A2 in a folded shape. The auxiliary box B2 may be provided with a fourth connecting portion (not shown), and the auxiliary box B2 is connected and disposed in the housing B1 through the fourth connection portion by one of glue coating or double-sided tape sticking, so as to prevent the auxiliary box B2 from falling.

The foam packing bag A2 is as described above (also refer to FIG. 11). The at least one foam packing bag A2 includes an outer bag body 50 and an inner bag body 60, wherein the inner bag body 60 is located inside the outer bag body 50, and the inner bag body 60 is smaller than the outer bag body 50; the inner bag body 60 is provided with a first reaction area 60A and a second reaction area 60B that are adjacent to each other; the first reaction area 60A is provided inside with a first reactant S1, and the second reaction area 60B is provided inside with a second reactant S2; in the unfolded state, the first reactant S1 reacts with the second reactant S2 to form a foam after being mixed with each other, which bursts the inner bag body 60 and fills the outer bag body 50 with the foam.

As mentioned above, the invention may be folded to reduce the overall volume during transportation, may also reduce manufacturing costs and transportation costs, provide users with a more convenient use experience, and may complete the packaging quickly and conveniently by themselves.

The above description is only to illustrate the preferred implementation mode of the invention, and is not intended to limit the scope of implementation. All simple replacements and equivalent changes made according to the patent scope of the invention and the content of the patent specification all belong to the scope of the patent application of the invention.

What is claimed is:

1. A packing box, comprising:
a first plate module and a second plate module, the first plate module and the second plate module being of the same structure, both the first plate module and the second plate module respectively comprising:
a first panel, comprising a first main plate portion, a first upper closing portion, and a first lower closing portion, the first main plate portion being connected with the first upper closing portion, wherein a position where the first main plate portion is connected with the first upper closing portion is a first folded edge, the first main plate portion being connected with the first lower closing portion, and wherein a position where the first main plate portion is connected with the first lower closing portion is a second folded edge; and
a second panel, comprising a second main plate portion, a second upper closing portion, and a second lower closing portion, the second main plate portion being connected with the second upper closing portion, wherein a position where the second main plate portion is connected with the second upper closing portion is a third folded edge, the second main plate portion being connected with the second lower closing portion, and wherein a position where the second main plate portion is connected with the second lower closing portion is a fourth folded edge; the second main plate portion, the second upper closing portion, and the second lower closing portion being respectively provided with a bending area, wherein a plurality of the bending areas are connected with each other, and at least one deformed bending line is included between the plurality of the bending areas;
wherein the first main plate portion of the first plate module is connected with the second main plate portion of the second plate module, and the second main plate portion of the first plate module is connected with the first main plate portion of the second plate module;
a first auxiliary plate disposed at the first plate module, wherein one side of the first auxiliary plate is disposed on the second main plate portion of the first plate module, and the other side of the first auxiliary plate is movably in contact with the first main plate portion or the second main plate portion; in a folded state, the first auxiliary plate is attached to the first main plate portion of the first plate module, and in an unfolded state, the first auxiliary plate is attached to the second main plate portion of the first plate module; and
a second auxiliary plate disposed at the second plate module, wherein one side of the second auxiliary plate is disposed on the second main plate portion of the second plate module, and the other side of the first auxiliary plate is movably in contact with the first main plate portion or the second main plate portion; in the folded state, the second auxiliary plate is attached to the first main plate portion of the second plate module, and in the unfolded state, the second auxiliary plate is attached to the second main plate portion of the second plate module.

2. The packing box according to claim 1, wherein the first plate module and the second plate module are integrally formed.

3. The packing box according to claim 1, wherein a first connecting portion is provided between the first plate module and the second plate module, and the first plate module and the second plate module are connected with each other through the first connecting portion.

4. The packing box according to claim 1, wherein the first auxiliary plate is connected with the first plate module, and the second auxiliary plate is connected with the second plate module, through a second connecting portion respectively.

5. The packing box according to claim 1, in the unfolded state, the other side of the first auxiliary plate and the other side of the second auxiliary plate are attached by a third connecting portion respectively.

6. The packing box according to claim 1, wherein from the folded state to the unfolded state, a moving angle of the first auxiliary plate and a moving angle of the second auxiliary plate are between 0° and 90°.

7. The packing box according to claim 1, wherein the first main plate portion, the first upper closing portion, the first upper closing portion, the second main plate portion, the second upper closing portion, and the second lower closing portion are respectively provided with an inner receiving surface and an outer receiving surface that are opposite to each other; and
the first auxiliary plate and the second auxiliary plate are respectively provided with an inner contact surface and an outer reinforced surface that are opposite to each other.

8. The packing box according to claim 7, wherein in the folded state, the packing box is a multi-layer stacked structure, and a stack type of the multi-layer stacked structure is:
in the first plate module, the first upper closing portion partially overlaps the first lower closing portion, and the outer surface of the first upper closing portion and the outer surface of the first lower closing part are in contact with the outer surface of the first main plate portion, the inner receiving surface of the first main plate portion being in contact with the inner contact surface of the first auxiliary plate;
in the second plate module, the first upper closing portion partially overlaps the first lower closing portion, and the outer surface of the first upper closing portion and the outer surface of the first lower closing part are in contact with the outer surface of the first main plate portion, the inner receiving surface of the first main plate portion being in contact with the inner contact surface of the second auxiliary plate;
in the first plate module, the second upper closing portion partially overlaps the second lower closing portion and is bent along the plurality of the deformed bending lines, and the inner receiving surface of the second upper closing portion, the inner receiving surface of the second lower closing portion are in contact with the inner receiving surface of the second main plate portion, the outer surface of the second main plate portion being centered on the deformed bending line so that the outer surfaces are folded and in contact with each other; and
in the first plate module and the second plate module, the outer surface of the second upper closing portion and the outer surface of the second lower closing portion are bent with the deformed bending line as a center, so that the outer surface of the second upper closing portion and the outer surface of the second lower closing portion are in contact with the outer reinforced surface of the first auxiliary plate and the outer reinforced surface of the second auxiliary plate respectively, and the deformed bending lines of the plurality of bending areas are close to a middle of the first main plate portion.

9. The packing box according to claim 1, wherein a material of the first plate module, the second plate module, the first auxiliary plate, or the second auxiliary plate is one of plastic, decomposable plastic, paper, corrugated fiberboard, or artificial fiber.

10. The packing box according to claim 1, further comprising at least one foam packing bag, wherein the at least one foam packing bag is located at the first lower closing portion and the first upper closing portion of the first plate module, or is located at the first lower closing portion and the first upper closing portion of the second plate module; the at least one foam packing bag comprises an outer bag body and an inner bag body, the inner bag body being located in the outer bag body, the inner bag body being provided with a first reaction area and a second reaction area that are adjacent to each other; wherein a first reactant is provided in the first reaction area, and a second reactant is provided in the second reaction area; in the unfolded state, the first reactant reacts with the second reactant to form a foam after being mixed with each other.

11. A packing assembly, comprising:
a housing;
a packing box according to claim 1, the packing box being disposed in the housing in the folded state; and
an auxiliary box disposed in the housing and adjacent to the packing box, the auxiliary box comprising the at least one foam packing bag in a folded shape.

12. The packing assembly according to claim 11, wherein the at least one foam bag comprises an outer bag body and an inner bag body, and the inner bag body is located in the outer bag body, the inner bag body being smaller than the outer bag body, the inner bag body being provided with a first reaction area and a second reaction area that are adjacent to each other; a first reactant is provided in the first reaction area, and a second reactant is provided in the second reaction area; in the unfolded state, the first reactant reacts with the second reactant to form the foam after being mixed with each other.

13. The packing assembly according to claim 11, wherein the auxiliary box is connected with the housing to prevent the auxiliary box from falling.
